(19) United States
(12) Patent Application Publication
(10) Pub. No.: US 2022/0371068 A1
(43) Pub. Date: Nov. 24, 2022

(54) SHAFT ASSEMBLY AND METHOD OF PRODUCING THE SAME

(71) Applicant: METAL FORMING & COINING CORPORATION, Maumee, OH (US)

(72) Inventors: Timothy John Cripsey, Rochester, MI (US); Erik Piper, Harrison Township, MI (US); Robert Herston, New Baltimore, MI (US)

(21) Appl. No.: 17/664,715

(22) Filed: May 24, 2022

Related U.S. Application Data
(60) Provisional application No. 63/192,122, filed on May 24, 2021.

(51) Int. Cl. B21C 37/16; B21K 1/06

(52) U.S. Cl. CPC B21C 37/16; B21K 1/063; B21K 1/12

(57) ABSTRACT

A shaft assembly comprises a hollow shaft and at least one working component disposed therein. A method of forming the shaft assembly includes a step of providing at least one generally planar preform. The preform is then formed into a “U”-shaped partial cylinder. One or more working components may then be assembled and connected to an interior of the partial cylinder. The partial cylinder is then further formed into a hollow cylinder having a generally circular cross-sectional shape, thus surrounding the one or more working components to secure a position thereof in an interior of the hollow cylinder. The hollow cylinder may then be held stationary and a welding operation performed thereon to form the hollow shaft. Once the hollow shaft is welded, post process machining may then be performed thereon as desired to further finish the hollow shaft.

### CROSS-REFERENCE TO RELATED APPLICATION

This application claims the benefit of U.S. Provisional Patent Application Ser. No. 63/192,122, filed May 24, 2021, the entirety of which is herein incorporated by reference.

### FIELD

The invention relates to a shaft assembly, and more particularly to a shaft assembly for an electric motor and a method of producing the same.

### BACKGROUND

Different ways of cooling electric motors are known from the prior art to minimize heat-related losses which cause inefficiency of the electric motor. One possibility provides passive cooling in which the heat arising in the electric motor is conducted onto the machine structure via a fastening device. The heat can be transferred, for example, via a mounting of the rotor shaft. This leads to a thermally high loading of bearings which consequently have to be designed with appropriate dimensions. Another possibility provides active air cooling in which air is blown over the electric motor. Such air cooling, however, does not provide efficient heat dissipation from the electric motor, especially inner working thereof.

A further possibility resides in liquid cooling of the electric motor. Hollow shafts are often used in various electric motor shaft applications. Cooling liquids may pass through the hollow shafts, thereby reducing heat-related losses in the electric motor. Current “advanced” hollow shafts incorporate heating exchange units to help dissipate heat away from the rotors. In conventional hollow shaft designs, a heat exchange unit is inserted into an existing standard tube from one of the open ends thereof until seated in a desired location. Methods such as shrink fit are then used to ensure that these heat exchange units stay in place in the tube. A design of such hollow shafts is limited and can be costly to manufacture and assemble.

Accordingly, it would be desireable to produce a shaft assembly for an electric motor and a method of producing the same that increases design flexibility while minimizing manufacturing and assembly costs.

### SUMMARY

In concordance and agreement with the present invention, a shaft assembly for an electric motor and a method of producing the same that increases design flexibility while minimizing manufacturing and assembly costs, has surprisingly been discovered.

The present disclosure reflects a shaft assembly for an electric motor and a method of producing the same that provides at least the following advantages over the current state of the art: easier and lower cost assembly of internal components; lower cost of manufacturing; variable wall thickness and material type possible down a length of the tube; and increased design flexibility for product engineers.

In one embodiment, a shaft assembly, comprises: a hollow shaft; and at least one working component disposed within the hollow shaft, wherein a position of the at least one working component within the hollow shaft is secured during a forming of a preform into the hollow shaft.

In some embodiments, a wall thickness of the hollow shaft is constant from one end to another end thereof.

In some embodiments, a wall thickness of the hollow shaft varies from one end to another end thereof.

In some embodiments, an inner diameter of the hollow shaft is constant from one end to another end thereof.

In some embodiments, an inner diameter of the hollow shaft varies from one end to another end thereof.

In some embodiments, the at least one working component extends within the hollow shaft from one end to another end thereof.

In some embodiments, the hollow shaft includes a first end portion, a second end portion, and an intermediate portion formed therebetween.

In some embodiments, a wall thickness of the intermediate portion of the hollow shaft is less than a wall thickness of at least one of the first end portion and the second end portion thereof.

In some embodiments, an inner diameter of the intermediate portion of the hollow shaft is greater than an inner diameter of at least one of the first end portion and the second end portion thereof.

In some embodiments, a transition from the intermediate portion of the hollow shaft to at least one of the first end portion and the second end portion thereof is sloped.

In some embodiments, the at least one working component is disposed in the intermediate portion of the hollow shaft.

In some embodiments, the at least one working component is a thermal energy transfer element.

In some embodiments, the at least one working component is a magnet.

In another embodiment, a method of producing a shaft assembly, comprises: providing a generally planar preform; forming the preform into a partial cylinder having a generally “U” shaped cross-section; disposing at least one working component into the partial cylinder; and forming the partial cylinder around the at least one working component into the hollow cylinder have a generally circular cross-sectional shape.

In some embodiments, the method further comprises joining opposing longitudinal edges of the hollow cylinder by a weld to form a hollow shaft.

In some embodiments, the preform comprises a plurality of portions produced from at least one material.

In some embodiments, one of the portions is joined to another one of the portions by a weld.

In some embodiments, the weld joining the portions of the preform is transverse to a weld joining edges of the hollow cylinder to form a hollow shaft.

In yet another embodiments, a method of producing an electric motor shaft assembly, comprises: stamping at least one preform from at least one material; disposing at least one working component on the at least one preform; forming the preform into a partial cylinder having the at least one working component within the partial cylinder; and forming the partial cylinder into the hollow cylinder having a generally circular cross-sectional shape.

In some embodiments, the at least one working component is at least one of a thermal energy transfer element and a magnet.

### BRIEF DESCRIPTION OF THE DRAWINGS

The above-mentioned, and other features and objects of the inventions, and the manner of attaining them will become more apparent and the invention itself will be better understood by reference to the following description of embodiments of the invention taken in conjunction with the accompanying drawings, wherein:

FIGS. 1A-1E is a schematic representation of a method of forming a shaft assembly according to an embodiment of the disclosure;

FIG. 2A is a fragmentary perspective view of a shaft assembly according to another embodiment of the presently disclosed subject matter, the shaft assembly including a thermal energy transfer element disposed in a hollow shaft;

FIG. 2B is a schematic representation of a preform for forming the hollow shaft of FIG. 2A, the preform comprising a plurality of portions, wherein each of the portions is joined to another one of the portions by a welding operation;

FIG. 3A is a fragmentary perspective view of a shaft assembly according to another embodiment of the presently disclosed subject matter, the shaft assembly including a thermal energy transfer element disposed in a multi-diameter hollow shaft;

FIG. 3B is schematic representation of a single-portion preform for forming the multi-diameter hollow shaft of FIG. 3A;

FIG. 4A is a fragmentary perspective view of a shaft assembly according to another embodiment of the presently disclosed subject matter, the shaft assembly including a thermal energy transfer element disposed in a multi-diameter hollow shaft;

FIG. 4B is a schematic representation of a preform for forming the multi-diameter hollow shaft of FIG. 4A, the preform comprising a plurality of portions, wherein each of the portions is joined to another one of the portions by a welding operation;

FIG. 5 is a schematic fragmentary perspective view of a sheet of cooling fins used to form a thermal energy transfer element;

FIG. 6A is a fragmentary elevational view of a shaft assembly according to another embodiment of the presently disclosed subject matter;

FIG. 6B is a cross-sectional view of the shaft assembly of FIG. 6A, taken along section line A-A, showing an inner flow conduit formed by a sheet of cooling fins when a preform is formed into a hollow shaft;

FIG. 6C is a fragmentary cross-sectional view of the shaft assembly of FIG. 6A, taken along section line B-B; and

FIG. 6D is an enlarged view of a portion of the shaft assembly within circle C in FIG. 6B.

### DESCRIPTION OF THE PREFERRED EMBODIMENTS

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

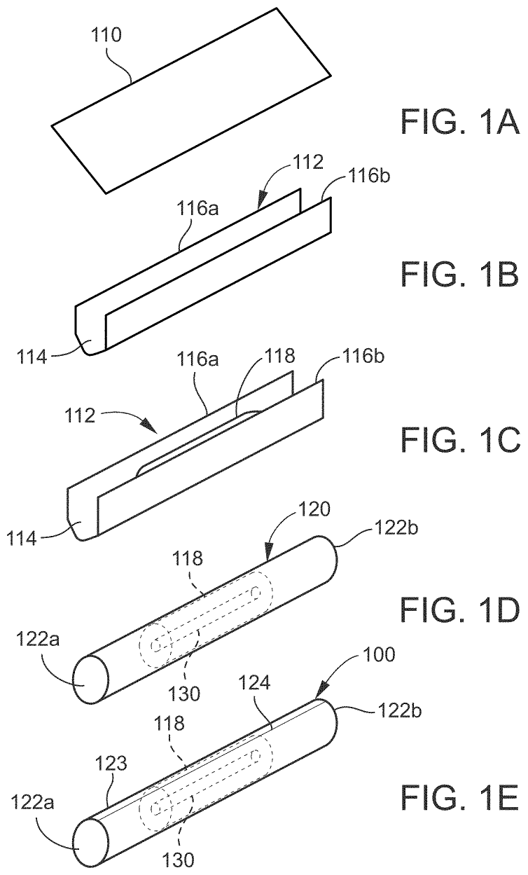

FIGS. 1A-1E depict a method of forming a shaft assembly 100 according to an embodiment of the presently described subject matter. The shaft assembly 100 may be employed in various applications such as commercial, industrial, residential, and agricultural applications, for example. In a preferred embodiment, the shaft assembly 100 may be used in an electric motor application to minimize heat-related losses in an electric motor (not depicted).

The method may include the step of providing a generally planar blank preform 110, as shown in FIG. 1A. Various materials may employed to produce the preform 110 such as a metal (e.g. steel) and a non-metal material, for example. The preform 110 is then formed into a generally “U”-shaped partial cylinder 112 by any known method. In a non-limiting example, the partial cylinder 112 may be formed by an initial “U” press hit of a press-forming operation. As shown in FIG. 1B, the partial cylinder 112 may comprise a channel 114 defined by a pair of side portions 116a, 116b. One or more working components 118 may then be disposed in the channel 114 as illustrated in FIG. 1C. In certain embodiments, at least one of the working components 118 may be a thermal energy transfer element (e.g. a heat exchanger). In another embodiment, at least one of the working components 118 may be a thermal energy transfer element having an inner conduit 130 configured to permit a fluid (i.e. a cooling fluid, refrigerant, lubricant, etc.) to flow therethrough. It is understood that the fluid may be any suitable fluid to transfer thermal energy from the electric motor to the fluid to dissipate heat. In yet other embodiments, at least one of the working components 118 may be a magnet. It is understood that more or less working components 118 than shown may be disposed within the partial cylinder 112 as desired. It is also understood that at least one of the working components 118 may be fixedly coupled to an interior of the channel 114 if desired.

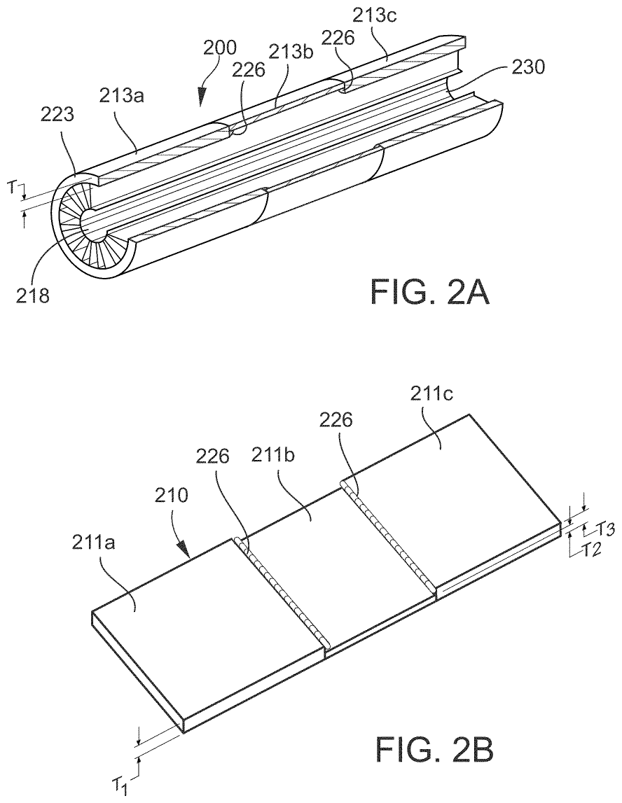

Thereafter, the partial cylinder 112 is then further formed into a generally cylindrical-shaped hollow cylinder 120 illustrated in FIG. 1D. As illustrated, each of the side portions 116a, 116b have a generally arcuate shape. The hollow cylinder 120 may include a pair of opposing open ends 122a, 122b. As best seen in FIGS. 2B, 3B, 4B, and 6B, the hollow cylinder 120 may be formed to surround the working components 118 to maintain a position of the working components 118 therein. The hollow cylinder 120 may then be formed into the hollow shaft 123, as depicted in FIG. 1E, by aligning and joining opposing longitudinal edges of the arcuate-shaped side portion 116a, 116b. In certain embodiments, the hollow cylinder 120 may be held stationary such as by using a clamp, and a welding operation performed along a juncture of the longitudinal edges forming a weld 124. The weld 124 may be formed along an entirety of the hollow shaft 123 from one open end 122a to the other open end 122b. Once the hollow shaft 123 is welded, post-process machining may then be performed thereon as desired such as to remove any burrs or further finish the hollow shaft 123. In some embodiments, at least one of the working components 18 may be fixedly coupled within the hollow shaft 123 during the forming of the hollow cylinder 120 into the hollow shaft 123. More preferably, at least one of the working components 118 may be fixedly coupled to the hollow cylinder 120, and thereby the hollow shaft 123, by controlling weld parameters during the welding operation performed to form the weld 124.

There are several advantages to using the disclosed method. The method maximizes a flexibility of design for different types of hollow shaft assemblies 100. In respect of the working components 118, especially thermal energy transfer elements including extrusions, plates, fins, and the like, these no longer need to be inserted from one of the open ends 122a, 122b of the hollow cylinder 120. The working components 118 can be easily inserted into the open “U” channel 114 prior to forming the hollow cylinder 120. This allows the working components 118 to be precisely aligned prior to final forming of the hollow shaft 123. The alignment can be easily maintained, which is not nearly as easy when attempting to install from one of the open ends 122a, 122b of the hollow cylinder 120.

Turning now to FIG. 2A, there is shown a shaft assembly 100 in accordance with another embodiment, a shaft assembly indicated generally by reference numeral 200. Similar structure of the shaft assembly 200 with the shaft assembly 100 share the same reference numerals, incremented by 100. A wall thickness T of the hollow shaft 223 can easily be varied along a length of the shaft assembly 200 as illustrated in FIG. 2A. Since a generally planar blank is used to produce the hollow shaft 223, it allows for a multi-portion preform 210 comprising a plurality of portions 211 to be used. Any number of portions 211 may be employed as desired. In one embodiment, each of the portions 211 may be a separate and distinct piece joined to another one of the portions 211 by any suitable method such as by a welding operation, for example.

As best seen in FIG. 2B, the multi-portion preform 210 may comprise a first portion 211a having a thickness T1, an intermediate second portion 211b having a thickness T2, and a third portion 211c having a thickness T3. As such, the preform 210 may have a variable thickness along a length thereof. In certain embodiments, the thickness T1 of the first portion 211a and the thickness T3 of the third portion 211c may be greater than the thickness T2 of the second portion 211b. Thus, the hollow shaft 223 may have a varying wall thickness T along the length thereof. In certain embodiments, a wall thickness of a first end portion 213a and a wall thickness of a third end portion 213c may be greater than a wall thickness of an intermediate second portion 213b.

The multi-portion preform 210 further allows different material types to be used at desired locations along the hollow shaft 223. It should be appreciated that each of the portions 211a, 211b, 211c may be formed from a different material or the same material, if desired. It is understood that the thickness T1, T2, T3 and material of each of the portions 211a, 211b, 211c, respectively, may be of such thickness and material so as to permit a desired amount and/or a maximum amount of thermal energy transfer from the hollow shaft 223 to the fluid flowing through the inner conduit 230 formed by and/or through the one or more working components 218 disposed within the hollow shaft 223. As illustrated in FIG. 2B, each of the portions 211a, 211b, 211c may be joined to another one of the portions 211a, 211b, 211c by a weld 226. The welds 226 may be formed transverse to the weld (not depicted) used to form the hollow shaft 223.

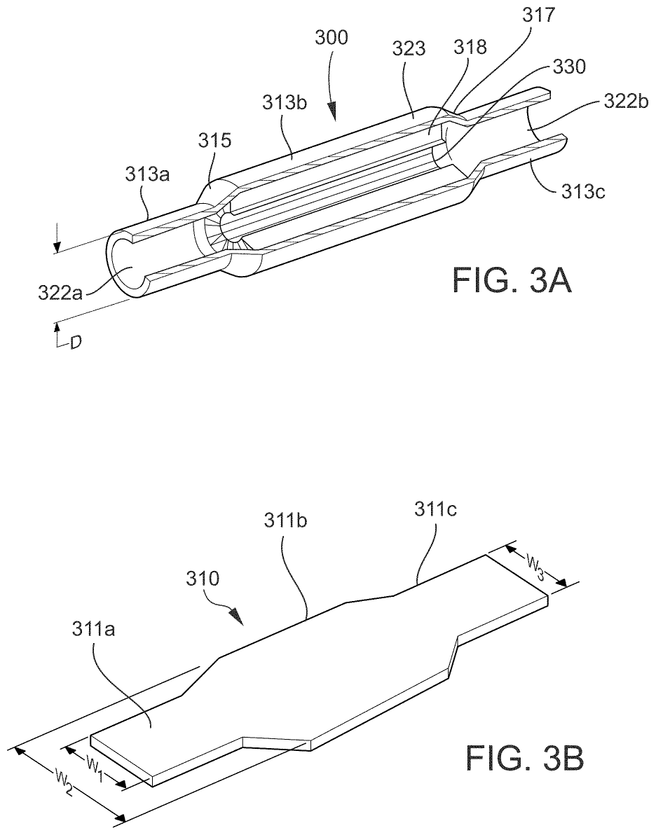

FIG. 3A illustrates a multi-diameter shaft assembly 300 in accordance with another embodiment of the presently disclosed subject matter. Similar structure of the hollow shaft assemblies 100, 200 with the shaft assembly 300 share the same reference numerals, incremented by 100. As shown in FIG. 3A, different diameters can be accommodated in the hollow shaft 323. The hollow shaft 323 may be manufactured with different diameters using secondary processes such as swaging. It should be noted that these processes have traditionally been slower (30-45 seconds) and may involve “relocating” the material from an original diameter of the hollow shaft 323 to a smaller diameter.

Starting with a preform 310 depicted in FIG. 3B, however, it is possible to form the hollow shaft 323 using a press-forming operation. More preferably, the hollow shaft 323 may be formed at a typical press-forming speed (6-10 seconds), directly to a final desired profile. As more clearly shown FIG. 3B, the preform 310 may comprise a first portion 311a having a width W1, an intermediate second portion 311b having a width W2, and a third portion 311c having a width W3. As such, the preform 310 may have a variable width along a length thereof In certain embodiments, the width W1 of the first portion 311a and the width W3 of the third portion 311c may be less than the width W2 of the second portion 311b. Thus, the hollow shaft 323 may have a varying diameter D along the length thereof. As shown, a diameter of a first end portion 313a and a diameter of a third end portion 313c may be less than a diameter of a intermediate second portion 313b. It is understood that the diameter of the intermediate second portion 313b may be any such diameter so as to receive at least one of the working components 318 therein. A transition 315 from the intermediate second portion 313b to at least one of the first end portion 313a and a transition 317 from the intermediate second portion 313b to the second end portion 313b thereof is sloped. It is understood that the transitions 315, 317 may be configured to maintain a position of the at least one of the working components 318 within the intermediate second portion 313b of the hollow shaft 323.

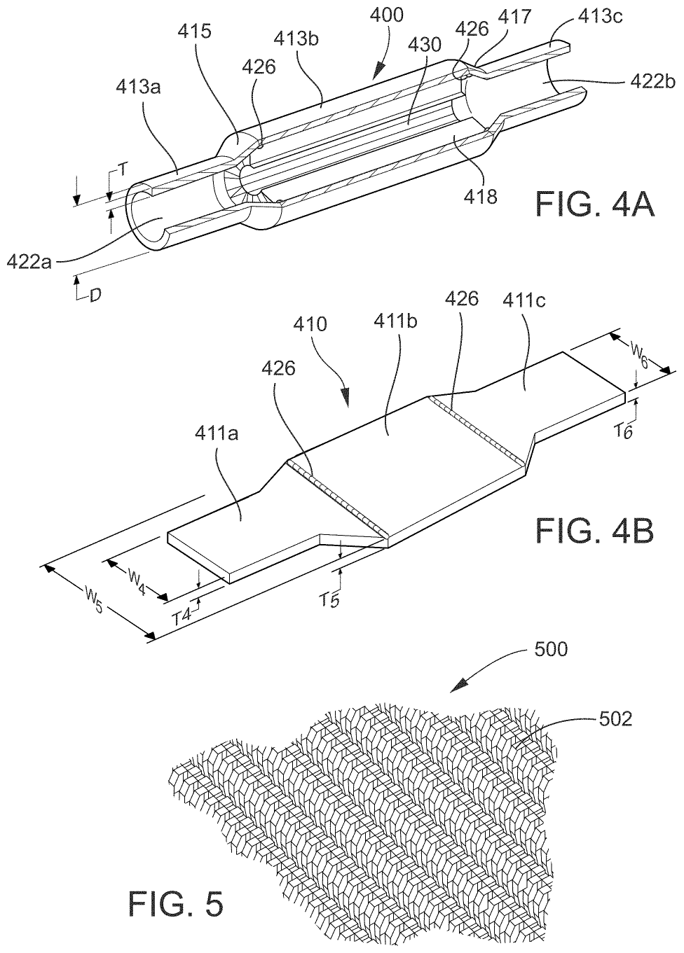

Turning now to FIG. 4A, there is shown a shaft assembly 400 in accordance with another embodiment of the presently disclosed subject matter. Similar structure of the hollow shaft assemblies 100, 200, 300 with the shaft assembly 400 share the same reference numerals, incremented by 100. A wall thickness T and a diameter D of the hollow shaft 423 can easily be varied along a length of the shaft assembly 400 as illustrated in FIG. 4A. Since a generally planar blank is used to produce the hollow shaft 423, it allows for a multi-portion preform 410 comprising a plurality of portions 411 to be used. Any number of portions 411 may be employed as desired. In one embodiment, each of the portions 411 may be a separate and distinct piece joined to another one of the portions 411 by any suitable method such as by a welding operation, for example.

As best seen in FIG. 4B, the multi-portion preform 410 may comprise a first portion 411a having a thickness T4 and a width W4, an intermediate second portion 411b having a thickness T5 and a width W5, and a third portion 411c having a thickness T6 and a width W6. As such, the preform 410 may have a variable thickness and a variable width along a length thereof. In certain embodiments, the thickness T4 of the first portion 411a and the thickness T6 of the third portion 411c may be greater than the thickness T5 of the second portion 411b. Thus, the hollow shaft 423 may have a varying wall thickness T along the length thereof In certain embodiments, a wall thickness of a first end portion 413a and a wall thickness of a third end portion 413c may be greater than a wall thickness of an intermediate second portion 413b.

In certain embodiments, the width W4 of the first portion 411a and the width W6 of the third portion 411c may be less than the width W5 of the second portion 411b. Thus, the hollow shaft 423 may have a varying diameter D along the length thereof. As shown, a diameter of a first end portion 413a and a diameter of a third end portion 413c may be less than a diameter of the intermediate second portion 413b. It is understood that the diameter of the intermediate second portion 413b may be any such diameter so as to receive at least one of the working components 418 therein. A transition 415 from the intermediate second portion 413b to at least one of the first end portion 413a and a transition 417 from the intermediate second portion 413b to the second end portion 413b thereof is sloped. It is understood that the transitions 415, 417 may be configured to maintain a position of the at least one of the working components 418 within the intermediate second portion 413b of the hollow shaft 423.

The multi-portion preform 410 further allows different material types to be used at desired locations along the hollow shaft 423. It should be appreciated that each of the portions 411a, 411b, 411c may be formed from a different material or the same material, if desired. It is understood that the thickness T4, T5, T6, the width W4, W5, W6, and material of each of the portions 411a, 411b, 411c, respectively, may be of such thickness, width, and material so as to permit a desired amount and/or a maximum amount of thermal energy transfer from the hollow shaft 423 to the fluid flowing through the inner conduit 430 formed by and/or through the one or more working components 418 disposed within the hollow shaft 423. As illustrated in FIG. 4B, each of the portions 411a, 411b, 411c may be joined to another one of the portions 411a, 411b, 411c by a weld 426. The welds 426 may be formed transverse to the weld (not depicted) used to form the hollow shaft 423.

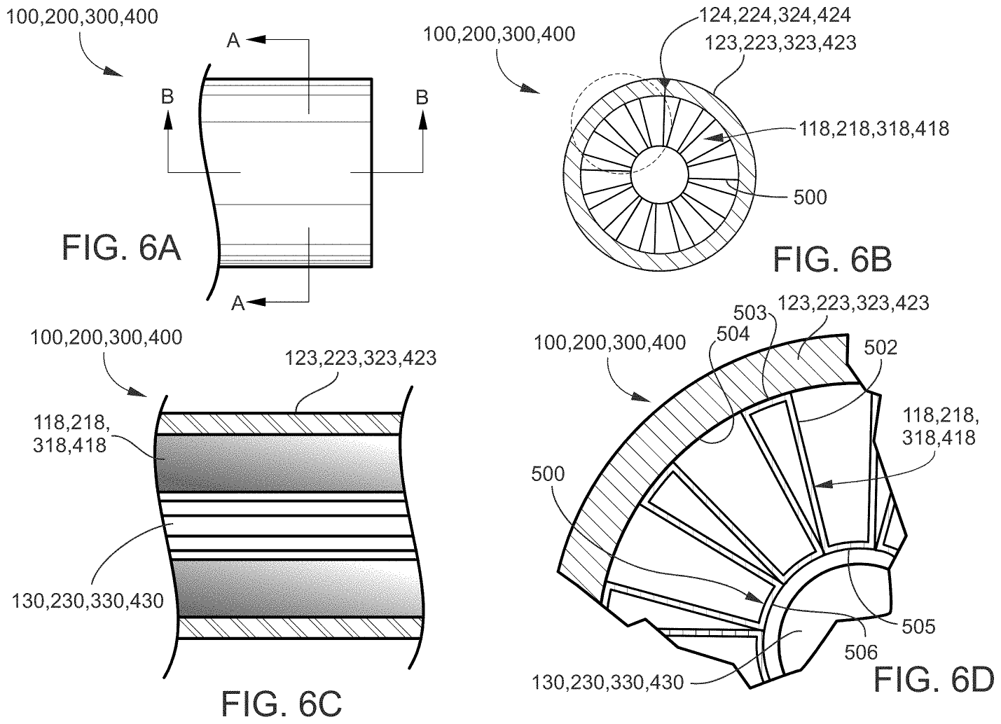

It should be appreciated that at least one of the working components 118, 218, 318, 418 may be formed from at least one piece of material 500. The piece of material 500 may have at least one surface irregularity 502 (e.g. extrusions, plates, fins, and the like) formed thereon and be produce from any suitable material as desired. For example, the piece of material 500 may be a “finned” steel or aluminum. It is understood that the piece of material 500 may include any number, shape, size, and configuration of surface irregularities 502 to provide a desired amount of thermal energy transfer from the hollow shaft 123, 223, 323, 423 to the fluid flowing through the conduit 130, 230, 330, 430. The piece of material 500 may be provided in a coil or flat form as shown in FIG. 5. In certain embodiments, a generally flat piece of material 500 may be placed on the preform 110, 210, 310, 410 and formed into the working component 118, 218, 318, 418 during the stamping process itself. With selection of a desired height and width of the surface irregularities 502 of the piece of material 500, the conduit 130, 230, 330, 430 may be created as the preform 110, 210, 310, 410 is formed into the hollow shaft 123, 223, 323, 423, shown in FIGS. 6A-6D. As best seen in FIG. 6D, the height and width of the surface irregularities 502 is such that radially outer portions 503 thereof are spaced apart and adjacent an inner surface 504 of the hollow shaft 123, 223, 323, 423, and radially inner portions 505 thereof abut one another to define a circumferential surface 506 of the conduit 130, 230, 330, 430. Accordingly, separate manufacturing to form the conduit 130, 230, 330, 430 within the working component 118, 218, 318, 418 and separate assembly of the working component 118, 218, 318, 418 is not required.

In one embodiment, when the piece of material 500 is disposed in the hollow shaft 123, 223, 323, 423, the height of the surface irregularities 502 is about 10 mm, the width of the radially outer portions 503 of the surface irregularities 502 is bout 3.15 mm, a radius from a central axis of the hollow shaft 123, 223, 323, 423 to the inner surface 504 thereof is about 16 mm, a radius from the central axis of the hollow shaft 123, 223, 323, 423 to the radially outer portions 503 is about 15.7 mm, and a space between each of the radially outer portions 503 is about 5.2 mm.

The disclosed method of FIGS. 1A-1E and the embodiments of the shaft assembly 100, 200, 300, 400, of FIGS. 1E, 2A, 3A, 4A also allows for ease of location and installation of the working components 118, 218, 318, 418, when at least one of the working components 118, 218, 318, 418 is a magnet. Magnet working components 118, 218, 318, 418 may be used for speed measurement and may be installed easily and at any location in or on the hollow shaft 123, 223, 323, 423, as desired.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A shaft assembly, comprising:
a hollow shaft; and
at least one working component disposed within the hollow shaft, wherein a position of the at least one working component within the hollow shaft is secured during a forming of at least one preform into the hollow shaft.

2. The shaft assembly of claim 1, wherein a wall thickness of the hollow shaft is constant from one end to another end thereof.

3. The shaft assembly of claim 1, wherein a wall thickness of the hollow shaft varies from one end to another end thereof.

4. The shaft assembly of claim 1, wherein an inner diameter of the hollow shaft is constant from one end to another end thereof.

5. The shaft assembly of claim 1, wherein an inner diameter of the hollow shaft varies from one end to another end thereof.

6. The shaft assembly of claim 1, wherein the at least one working component extends within the hollow shaft from one end to another end thereof.

7. The shaft assembly of claim 1, wherein the hollow shaft includes a first end portion, a second end portion, and an intermediate portion formed therebetween.

8. The shaft assembly of claim 8, wherein a wall thickness of the intermediate portion of the hollow shaft is less than a wall thickness of at least one of the first end portion and the second end portion thereof.

9. The shaft assembly of claim 8, wherein an inner diameter of the intermediate portion of the hollow shaft is greater than an inner diameter of at least one of the first end portion and the second end portion thereof.

10. The shaft assembly of claim 8, wherein a transition from the intermediate portion of the hollow shaft to at least one of the first end portion and the second end portion thereof is sloped.

11. The shaft assembly of claim 1, wherein the at least one working component is disposed in the intermediate portion of the hollow shaft.

12. The shaft assembly of claim 1, wherein the at least one working component is a thermal energy transfer element.

13. The shaft assembly of claim 1, wherein the at least one working component is a magnet.

14. A method of producing a shaft assembly, comprising:
providing a generally planar preform;
forming the preform into a partial cylinder having a generally “U” shaped cross-section;
disposing at least one working component into the partial cylinder; and
forming the partial cylinder around the at least one working component into a hollow cylinder have a generally circular cross-sectional shape.

15. The method of claim 14, further comprising joining opposing longitudinal edges of the hollow cylinder by a weld to form a hollow shaft.

16. The method of claim 14, wherein the preform comprises a plurality of portions produced from at least one material.

17. The method of claim 16, wherein one of the portions is joined to another one of the portions by a weld.

18. The method of claim 17, wherein the weld joining the portions of the preform is transverse to a weld joining edges of the hollow cylinder to form a hollow shaft.

19. A method of producing an electric motor shaft assembly, comprising:
stamping at least one preform from at least one material;
disposing at least one working component on the at least one preform;
forming the preform into a partial cylinder having the at least one working component within the partial cylinder; and
forming the partial cylinder into the hollow shaft having a generally circular cross-sectional shape.

20. The method of claim 19, wherein the at least one working component is at least one of a thermal energy transfer element and a magnet.
